(19) United States
(12) Patent Application Publication
(10) Pub. No.: US 2025/0340021 A1
(43) Pub. Date: Nov. 6, 2025

(54) ELECTROFUSION TOOL

(71) Applicant: MILWAUKEE ELECTRIC TOOL CORPORATION, Brookfield, WI (US)

(72) Inventor: Sam L. Bertz, Fox Point, WI (US)

(21) Appl. No.: 19/194,587

(22) Filed: Apr. 30, 2025

Related U.S. Application Data
(60) Provisional application No. 63/641,606, filed on May 2, 2024.
(60) Provisional application No. 63/683,751, filed on Aug. 16, 2024.

(51) Int. Cl. B29C 65/30; B29C 65/00; F16L 47/02; H02J 7/00; H05B 3/06

(52) U.S. Cl. CPC B29C 65/30; B29C 66/5221; B29C 66/95; F16L 47/02; H02J 7/0047; H05B 3/06

(57) ABSTRACT

An electrofusion tool used in joining pipe ends of plastic pipes together via a pipe fitting during an electrofusion process includes a housing, a battery receptacle to selectively receive a rechargeable battery pack, and electrical leads extending from the housing and configured to transfer a current from the battery pack to the pipe fitting for permanently joining the pipe ends together. The electrofusion tool also includes an electronic control unit configured to initiate a first system pre-check to determine whether an estimated peak operating current is less an output capacity of the electrofusion tool, a second system pre-check to determine whether an estimated electrical energy of the battery pack is less than a remaining charge capacity of the battery pack, and a third system pre-check to determine whether an estimated operating temperature of the battery pack is less than a set temperature threshold of the battery pack.

### CROSS-REFERENCE TO RELATED APPLICATIONS

This application claims priority to U.S. Provisional Application No. 63/683,751, filed Aug. 16, 2024, and to U.S. Provisional Application No. 63/641,606, filed May 2, 2024, the entire contents of both of which are incorporated by reference herein.

### FIELD

The present disclosure relates to a heat welding tool and, more particularly, to an electrofusion tool for heat welding two or more plastic pipes together.

### BACKGROUND

Electrofusion is a method of joining plastic pipes by using electrical current to melt the pipes and fittings together, thereby joining the pipes as they cool. The fittings typically include electric heating elements that receive electrical energy from an electrofusion tool to heat the pipes. Most electrofusion tools receive power from an AC power source.

### SUMMARY

In some aspects, the techniques described herein relate to an electrofusion tool used in joining pipe ends of plastic pipes together via a pipe fitting during an electrofusion process, the electrofusion tool including: a housing; a battery receptacle to selectively receive a rechargeable battery pack; electrical leads extending from the housing and configured to transfer a current from the battery pack to the pipe fitting for permanently joining the pipe ends together; and an electronic control unit configured to execute one or more steps, prior to initiating the electrofusion process, selected from a group consisting of: conduct a first system pre-check to determine whether an estimated peak operating current is less than an output capacity of the electrofusion tool, conduct a second system pre-check to determine whether an estimated electrical energy of the battery pack is less than a remaining charge capacity of the battery pack, and conduct a third system pre-check to determine whether an estimated operating temperature of the battery pack is less than a set temperature threshold of the battery pack.

In some aspects, the techniques described herein relate to a method of operating an electrofusion tool to join pipe ends of plastic pipes together via a pipe fitting during an electrofusion process, the method including: providing a battery pack for the electrofusion tool; connecting electrical leads from the electrofusion tool to the pipe fitting; scanning the pipe fitting to obtain pipe fitting characteristics; and executing, by an electronic control unit of the electrofusion tool and prior to initiating the electrofusion process, one or more steps selected from a group consisting of: a first system pre-check to determine whether an estimated peak operating current is less than an output capacity of the electrofusion tool, a second system pre-check to determine whether an estimated electrical energy of the battery pack is less than a remaining charge capacity of the battery pack, and a third system pre-check to determine whether an estimated operating temperature of the battery pack is less than a set temperature threshold of the battery pack.

Other aspects of the disclosure will become apparent by consideration of the detailed description and accompanying drawings.

### BRIEF DESCRIPTION OF THE DRAWINGS

FIG. 1 is a perspective view of an electrofusion tool in accordance with an embodiment of the invention, illustrating electrical leads electrically connectable to a pipe fitting.

FIG. 2 is a perspective view of the pipe fitting that may receive pipe ends of separate PE pipes, illustrating electrical terminals that electrically connect to the electrical leads of the electrofusion tool.

FIG. 3 is a perspective view of the electrofusion tool of FIG. 1, illustrating a depleted battery pack being removed from the electrofusion tool and a new, fully charged battery pack from a battery charger being installed in the electrofusion tool.

FIG. 4 is a schematic diagram of the electrofusion tool of FIG. 1, illustrating a user interface and an electronic control unit that controls operation of the electrofusion tool.

FIG. 5 is a flow chart illustrating a fusion process performed by the electrofusion tool.

FIG. 6 is a flow chart illustrating a process for a first system pre-check of the electrofusion tool.

FIG. 7 is a flow chart illustrating a process for a second system pre-check of the electrofusion tool.

FIG. 8 is a graph illustrating part of the process of the second system pre-check.

FIG. 9 is an exemplary table illustrating various metrics of battery packs that are stored by the electronic control unit during the second system pre-check of the electrofusion tool.

FIG. 10 is a flow chart illustrating a process for the third system pre-check of the electrofusion tool.

### DETAILED DESCRIPTION

Before any embodiments of the disclosure are explained in detail, it is to be understood that the invention is not limited in its application to the details of construction and the arrangement of components set forth in the following description or illustrated in the following drawings. The invention is capable of other embodiments and of being practiced or of being carried out in various ways.

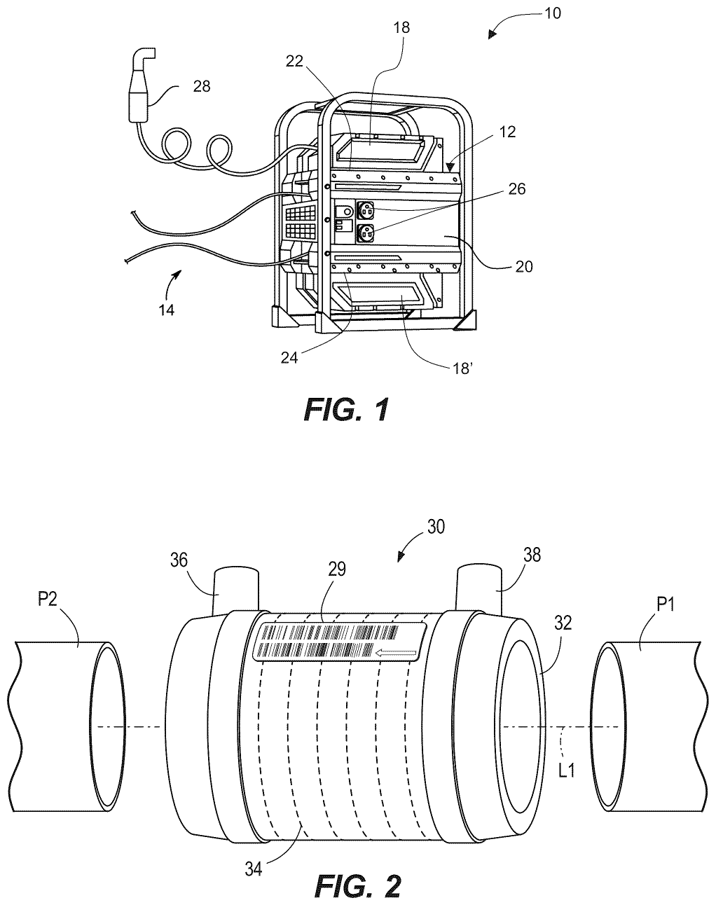

FIG. 1 illustrates a battery-operated electrofusion tool 10. The electrofusion tool 10 includes a housing 12, a pair of electrical leads 14 extending from the housing 12, a battery pack 18 that is selectively coupled to the housing 12, and an electronic control unit 20 that controls the distribution of power from the battery pack 18 and controls operation of the electrofusion tool 10. The battery pack 18 provides power to the electrofusion tool 10 and electrical current across the electrical leads 14 through the electronic control unit 20. In the illustrated embodiment, there are two battery packs 18, 18′, where one battery pack 18 is configured to be coupled to a battery receptacle 22 at one side of the housing 12 while the other battery pack 18 is configured to be coupled to a separate battery receptacle 24 at an opposite side of the housing 12. In other embodiments, there may be few or greater than two battery packs 18, 18′. The electrofusion tool 10 further includes an A/C outlet 26 that may be connected to a wall outlet to receive power therefrom via a power cord.

The battery packs 18, 18′ may be a power tool battery pack generally used to power a power tool, such as drills, electric saws, and the like (e.g., an 18-volt, 24-volt, 36-volt, 72-volt rechargeable battery pack, etc.). Specifically, the illustrated battery packs 18, 18′ are a high-power battery pack having a nominal voltage of up to about 80V. The battery packs 18, 18′ may include lithium ion (Li-ion) cells that are operable to output a sustained operating discharge current of between about 40 A and about 60 A. In alternative embodiments, the battery packs 18, 18′ may be of a different chemistry (e.g., nickel-cadmium, nickel-hydride, and the like).

The electronic control unit 20 includes a plurality of semi-conductor switching elements (e.g., MOSFETs, IGBTs, or the like) that control and distribute power to the electrical leads 14. The electronic control unit 20 may also include one or more microprocessors, machine-readable, non-transitory memory elements, and other electrical or electronic elements for providing operational control to the electrofusion tool 10. The electronic control unit 20 may be operatively coupled by a wired, a WiFi, or a wireless connection, or other suitable connections and may provide a remote device (e.g., smartphone, laptop, etc.) with status updates of the electrofusion tool 10. For example, the electronic control unit 20 may send signals to notify a remote device when the electrofusion tool 10 is in various operating modes and/or the status of an electrofusion process. The remote device may also receive signals from the electronic control unit 20 indicative of various data metrics of the tool 10 or an electrofusion process.

With reference to FIGS. 1 and 2, the electrofusion tool 10 further includes a scanner 28 that is configured to scan a barcode 29 of the pipe fitting 30. The barcode 29 is encoded with pipe fitting characteristics (e.g., voltage required, voltage time, curing time, etc.) indicating various performance metrics for completing the electrofusion process. Once scanned, the pipe fitting characteristics of the pipe fitting 30 are relayed and stored in the electronic control unit 20. The scanner 28 of the illustrated embodiment is an optical scanner that employs light beams to scan and digitally convert the barcode 29 to obtain the pipe fitting characteristics of the pipe fitting 30. In other embodiments, the scanner 28 may alternately be an RFID scanner configured to scan an RFID tag associated with the pipe fitting, a QR code scanner configured to scan a QR code associated with the pipe fitting, or some other suitable type of scanner.

With reference to FIG. 2, the pipe fitting 30 includes a cylindrical body 32 defining a longitudinal axis L1, a heat conductive coil 34 disposed within the cylindrical body 32, a positive terminal 36, and a negative terminal 38. The heat conductive coil 34 is disposed helically around the longitudinal axis L1 and embedded within the cylindrical body 32. The heat conductive coil 34 is configured to heat the inner periphery of the pipe fitting 30 when electrical current is traveling through the coil 34. The positive and negative terminals 36, 38 extend outward from the outer periphery of the pipe fitting 30 and are electrically connected to the heat conductive coil 34. The electrical leads 14 may be electrically connected to the positive and negative terminals 36, 38 to supply the coil 34 with electrical current. In other embodiments, the positive and negative terminals 36, 38 may be shaped and sized differently depending on the size of the pipe fitting 30. The pipe fitting 30 is configured to receive pipe ends of two separate plastic or polyethylene (PE) pipes P1, P2. Specifically, the PE pipes P1, P2 are axially aligned with the longitudinal axis L1 of the cylindrical body 32 and inserted at opposite ends of the pipe fitting 30 until the PE pipes P1, P2 contact (or nearly contact) each other near the middle. The pipe fitting 30 is available in different sizes to accommodate different size pipe ends. In some embodiments, the PE pipes P1, P2 may alternatively be PVC pipes or pipes of other materials.

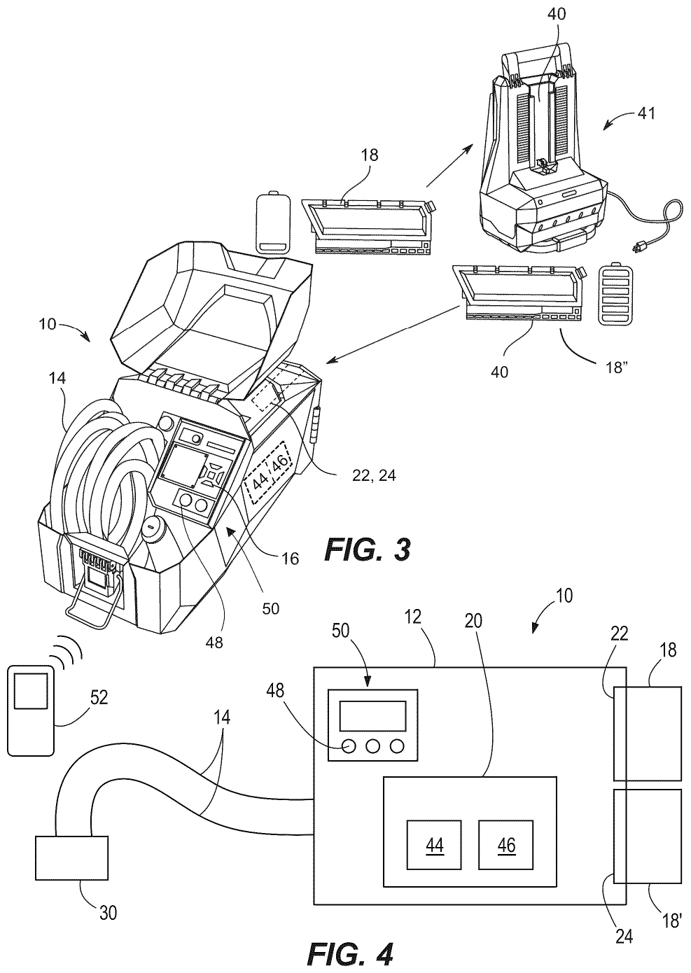

As previously mentioned, the electrofusion tool 10 may selectively receive the battery packs 18, 18′. As noted above, in some embodiments, the electrofusion tool 10 may only receive on battery pack 18. With reference to FIG. 3, the battery packs 18, 18′ include terminals 40 that enable the battery packs 18, 18′ to connect to the battery receptacles 22, 24 of the housing 12 or a battery charger 42. The terminals 40 of the battery pack 18 electrically connect to the electronic control unit 20 to transfer power or other data therebetween. For example, the electronic control unit 20 obtains a temperature of the battery packs 18, 18′ via the terminals 40. A temperature sensor (e.g., thermistor) 44 is provided to monitor the temperature of the battery pack 18, 18′, the electronic control unit 20, or the battery charger 42. As shown in FIGS. 3 and 4, the temperature sensor 44 is provided in the electrofusion tool 10, while in other embodiments, the temperature sensor 44 is provided in the battery packs 18, 18′. The electronic control unit 20 also obtains a state of charge of the battery packs 18, 18′ via the terminals 40. A voltage sensor 46 is provided to monitor the state of charge of the battery pack 18, 18′. As shown in FIGS. 3 and 4, the voltage sensor 46 is provided in the electrofusion tool 10, while in other embodiments, the voltage sensor 46 is provided in the battery packs 18, 18′. The temperature sensor 44 and the voltage sensor 46 send signals to the electronic control unit 20 indicating various data of the battery pack 18, 18′, at which point the electronic control unit 20 regulates the electrofusion tool 10 accordingly. In alternate embodiments, the sensors 44, 46 may also control aspects of charging and/or discharging of the battery packs 18, 18′.

As shown in FIG. 3, when the charge of either battery pack 18, 18′ is depleted, the depleted battery pack 18, 18′ can be removed and placed on the battery charger 42 to charge while a new battery pack 18″ that is fully charged is installed in the electrofusion tool 10. That is, the electrofusion tool 10 may receive the battery packs 18, 18′, 18″ interchangeably.

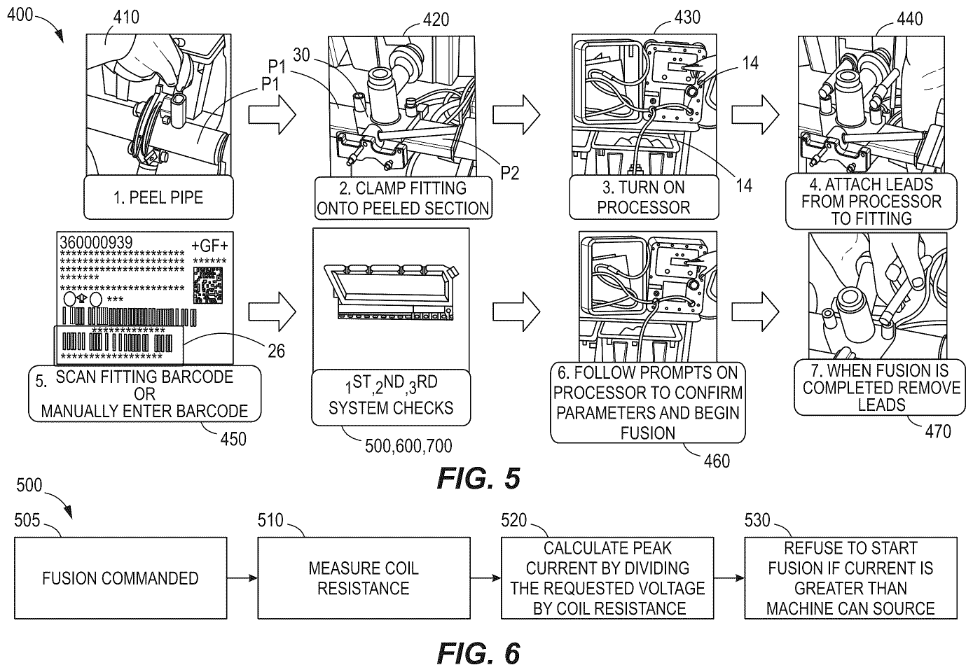

With reference to FIG. 5, the electrofusion tool 10 is used to combine two separate PE pipes P1, P2 into a single PE pipe during an electrofusion process 400. The electrofusion process 400 begins with a user peeling the outer layer of plastic from each PE pipe P1, P2 to make a clean connection (step 410). Next, the PE pipes P1, P2 are inserted into the pipe fitting 30 along the longitudinal axis L1 until they meet near the middle, at which point each PE pipe P1, P2 is clamped and stabilized (step 420). The electrofusion tool 10 is then turned on (step 430) and the electrical leads 14 are connected to the pipe fitting 30 (step 440). Specifically, the positive electrical lead is connected to the positive terminal 36 of the pipe fitting 30 and the negative electrical lead is connected to the negative terminal 38 on the pipe fitting 30. Using the scanner 28, the user scans the barcode 29 on the pipe fitting 30 where the electrofusion tool 10 collects and stores the pipe fitting characteristics (step 450) in the electronic control unit 20. Based on the pipe fitting characteristics and state of the battery pack 18 (e.g., temperature, charge, etc.), the electrofusion tool 10 performs one or more system pre-checks. In the illustrated embodiment, the electrofusion tool 10 may perform three system pre-checks: a first system pre-check 500, a second system pre-check 600, and a third system pre-check 700 prior to supplying any electrical current to the electrical leads 14, as described below. In other embodiments, the electrofusion tool 10 may only perform a single system pre-check or a subset (e.g., two) of the system pre-checks.

In some scenarios, the electrofusion tool 10 only begins supplying electrical current to the electrical leads 14 from the battery packs 18, 18′ (step 460) upon successfully completing the first system pre-check 500, the second system pre-check 600, and the third system pre-check 700. If all three pre-checks are satisfactory, as explained below, the electronic control unit 20 enables the battery packs 18, 18′ to supply electrical current to the electrical leads 14 in accordance with the pipe fitting characteristics. If any of the system pre-checks 500, 600, 700 is unsatisfactory or unsuccessful, the electronic control unit 20 may inhibit or stop operation of the electrofusion tool 10. In embodiments where the electrofusion 10 only performs a single system pre-check or a subset of the system pre-checks, only those system pre-checks that are performed may need to be satisfactory for the electronic control unit 20 to enable the battery packs 18, 18′ to supply electrical current to the electrical leads 14.

FIG. 6 illustrates the process of the first system (or tool) pre-check 500, which determines if the fusion process 400 is within an output capacity of the electrofusion tool 10. Specifically, the first system pre-check 500 ensures that an estimated peak operating current is within the output capacity of the electrofusion tool 10. The first system pre-check 500 starts with commanding the electrofusion to begin (step 505). This may occur in response to a user pressing an on/off button 48 or some other series of buttons on a user interface 50 of the electrofusion tool 10. Alternatively, a user may initiate step 505 via a mobile device 52 (e.g., smartphone, laptop, tablet etc.). At this point, the first system pre-check 500 begins measuring a resistance of the heat conductive coil 34 (step 510). The resistance is measured by applying a known electrical current to the heat conductive coil 34 and measuring the voltage drop across the heat conductive coil 34 to determine the coil resistance. Next, the estimated peak operating current is obtained by dividing a requested voltage obtained from the barcode 29 by the measured resistance in the conductive coil 34 (step 520). Finally, the estimated peak operating current is compared to the maximum current output that the electrofusion tool 10 can produce. If the peak operating current exceeds the maximum current of the processor tool 10, the first system pre-check 500 fails and the fusion process 400 does not proceed to step 460. If, on the other hand, the peak operating current is less than the maximum current output of the processor tool 10, the first system pre-check 500 is successful and the fusion process 400 proceeds to the remaining system pre-checks 600, 700. In some embodiments, the peak operating current may be compared to a percentage of the maximum current output that the electrofusion tool 10 can apply (e.g., 90% or 80% of maximum current output).

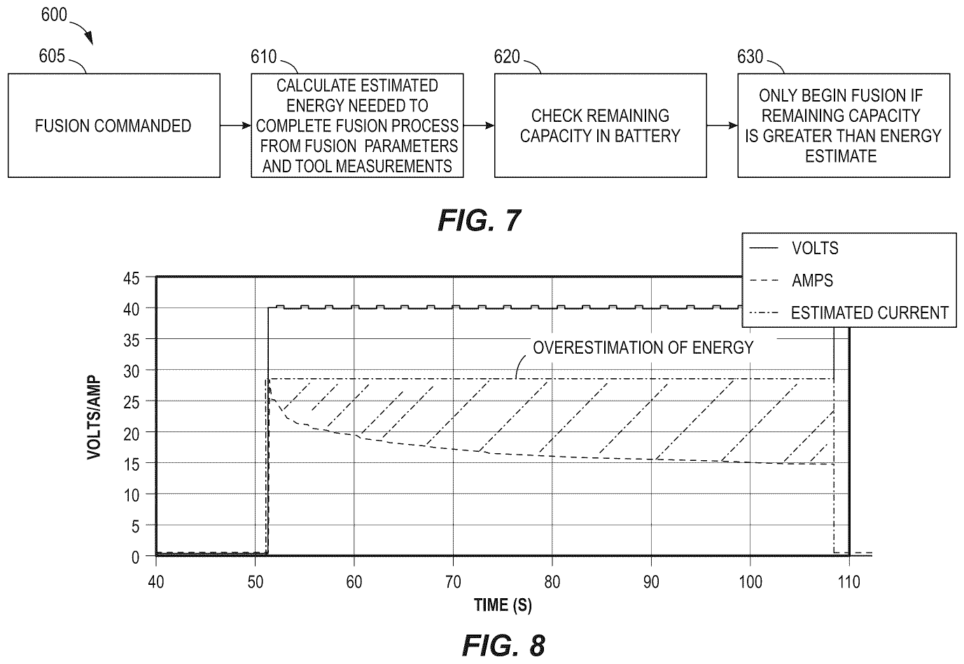

FIG. 7 illustrates the process of the second system (or battery) pre-check 600, which compares a remaining charge capacity of the battery packs 18, 18′ obtained from the voltage sensor 46 to an estimated Energy Required to complete the fusion process 400. The second system pre-check 600 starts with commanding the electrofusion to begin (step 605). For example, this may occur in response to a user pressing an on/off button 48 or some other series of buttons on a user interface 50 of the electrofusion tool 10. Alternatively, a user may initiate step 605 via a mobile device 52 (e.g., smartphone, laptop, tablet etc.). Still, in other embodiments, the system pre-check 600 may automatically begin following the completion of the first system pre-check 500. At this point, the second system pre-check 600 begins estimating the Energy Required for the fusion process 400 based on the pipe fitting characteristics obtained from the barcode 29 (step 610). The Energy Required (in Joules) for electrofusion can be calculated with the following formula:

$$Energy Required ( Joules ) = \frac{{V}^{2}}{{R}_{coil}} * time ,$$

where V is the voltage specified by barcode 29,
where R_{coil} is the resistance of heat conductive coil 34, and
where time is the operation time specified by barcode 29.

Then, as shown in FIG. 8, the Energy Required for the electrofusion is converted into a measurement of capacity in amp-hours. The Energy Required converted into amp-hour gives Capacity Required (in Ah) and can be determined through the following formula:

$$Capacity Required ( Ah ) = \frac{Energy Required}{{V}_{nominal} * 3600 seconds} ,$$

where Vₙₒₘᵢₙₐₗ is the lowest average voltage rating across the battery packs 18, 18′.

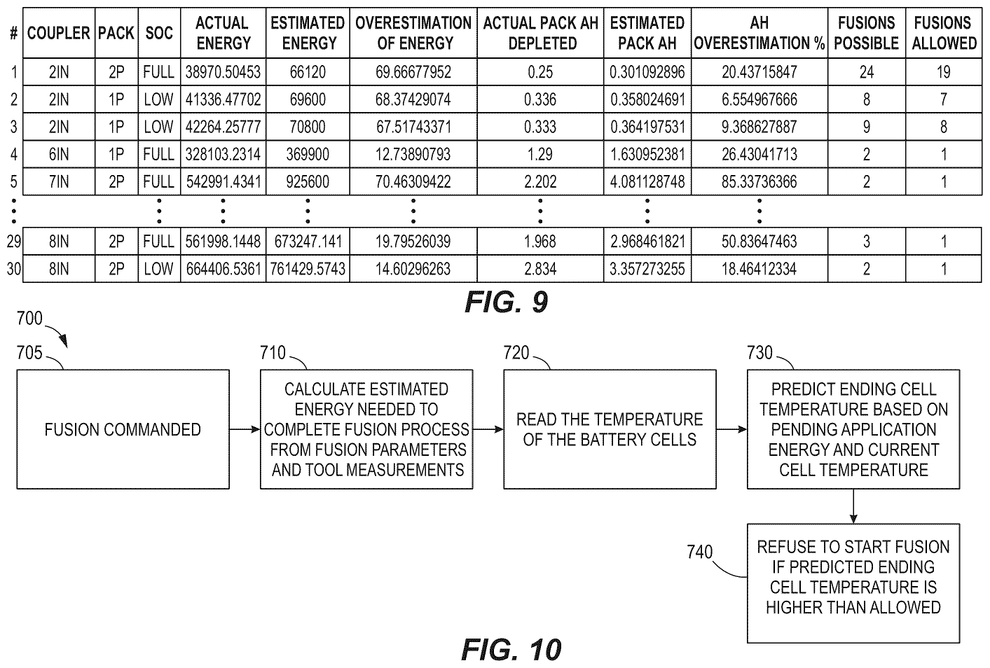

In some embodiments, the nominal voltage value (Vₙₒₘᵢₙₐₗ) may be set as an average voltage rating of the battery packs 18, 18′ connected to the tool 10 or as the lowest voltage rating of the battery pack 18, 18′ to avoid over-estimating. For example, if one battery pack 18 is 60V at max capacity and the other battery 18′ is 54V at max capacity, the nominal voltage value may be set to 57V (i.e., (60V+54V)/2=57V). Furthermore, the nominal voltage value may be derated based on the age of the battery packs 18, 18′. That is, the nominal voltage value may get derated to account for loss of voltage capacity that occurs as batteries age (FIG. 7). To aid in this process, the electronic control unit 20 actively stores characteristics (e.g., state-of-charge, estimated energy, overestimation of energy, actual pack Ah depleted, estimated pack Ah depleted, Ah overestimation percentage, remaining fusions possible, actual fusions allowed, etc.) of, for example, the last thirty (30) batteries used with the electrofusion tool 10, as shown in look-up-table (LUT) of FIG. 9. Along with the LUT, the electronic control unit 20 tracks a scalar to modify estimates based on how accurate previous reading were with that specific battery pack. The goal is to derate the battery packs 18, 18′ for age by 20% (i.e., overestimate the depletion of Ah by 20%). Next, the electrofusion tool 10 compares the Capacity Required for performing the electrofusion to the remaining capacity of the battery pack 18, 18′ (step 620). If the remaining capacity of the battery packs 18, 18′ does not exceed the Capacity Required, the second system pre-check 600 fails and the electrofusion tool 10 refuses to supply any electrical current to the heat conductive coil 34. If, on the other hand, the remaining capacity of the battery packs 18, 18′ exceeds the Capacity Required, the second system pre-check 600 is successful and the remaining system pre-check 700 is performed. As previously mentioned, the remaining capacity of the battery packs 18, 18′ is obtained via the voltage sensor 46. In some embodiments, a minimum cutoff amp-hour for the battery pack 18, 18′ may also be determined prior to beginning the electrofusion process, so that the electronic control unit 20 knows the floor (i.e., empty state) of the battery packs 18, 18′ to avoid depleting beyond the floor. The electronic control unit 20 sets the minimum cutoff Ah, for example, to 10% of the maximum Ah.

FIG. 10 illustrates the process of the third system pre-check 700, which is configured to estimate the operating temperature of the battery packs 18, 18′ to ensure the operating temperature is lower than a set temperature threshold prior to activating the electrofusion tool 10 in step 460. Battery overheating may cause damage to the battery packs 18, 18′, so it is desirable to avoid overheating the battery packs 18, 18′. The third system pre-check 700 starts with commanding the electrofusion to begin (step 705). For example, this may occur in response to a user pressing an on/off button 48 or some other series of buttons on a user interface 50 of the electrofusion tool 10. Alternatively, a user may initiate step 705 via a mobile device 52 (e.g., smartphone, laptop, tablet etc.). Still, in other embodiments, the system pre-check 700 may automatically begin following the completion of the first system pre-check 500 and/or the second system pre-check 600. At this point, the third system pre-check 700 starts by estimating the Energy Required to complete the electrofusion based on the pipe fitting characteristics obtained from the barcode 29 (step 710) on the pipe fitting 30. Alternatively, the previously obtained Energy Required from the second system pre-check 600 may be stored in the electrofusion tool 10 and used for the third system pre-check 700. Next, the electrofusion tool 10 obtains the present temperature of each of the cells of the battery packs 18, 18′ from the temperature sensor 44 and stores each temperature value (step 720). Based on the Energy Required for the fusion process 400 and the present temperature value of each cell of the battery packs 18, 18′, the electrofusion tool 10 predicts an operating temperature of each cell of the battery pack 18, 18′ (step 730). For example, the operating temperature may be a peak or ending operating temperature of each cell based on the Energy Required to complete a particular fusion process and the present temperature of each cell. Finally, the estimated operating temperatures of the battery packs 18, 18′ are compared to the set temperature threshold (step 740). If the estimated operating temperature exceeds the set temperature threshold, the third system pre-check 700 fails and the electrofusion tool 10 refuses to supply any electrical current to the heat conductive coil 34. If, on the other hand, the estimated operating temperature falls below the set temperature threshold, the third system pre-check 700 is successful and the electrofusion tool 10 is activated and proceeds to step 460. That is, the electronic control unit 20 authorizes the electrofusion tool 10 to begin the electrofusion process.

As an example, the pipe fitting 30 may come in various sizes (e.g., 2-inch diameter, 4-inch diameter, 6-inch diameter, 8-inch diameter, etc.), with larger sizes requiring more electrical current to complete the electrofusion process. If the electrical current that's required is greater than the designed discharge rating of the battery packs 18, 18′, the battery packs 18, 18′ may overheat, and thus, the electronic control unit 20 may refuse to initiate the electrofusion process. Generally, the battery packs 18, 18′ with a 6 Ah rating are designed to produce 60 amps with a 10% overage capability for every 2 Ah above 3 Ah. That is, a 6 Ah battery pack 18, 18′ may produce a maximum of 69 amps (i.e., 60 amp+((6 Ah−3 Ah)/2 Ah)*0.1*60)=69 amps) for short periods of time. Beyond that, the 6 Ah battery packs 18, 18′ begin to overheat. Generally speaking, the 6 Ah battery packs 18, 18′ are sufficient to complete the electrofusion process for any pipe fitting with a diameter of 6 inches or less. A pipe fitting that is 8 inches, for example, may require 80 amps to complete the electrofusion process which would overheat the 6 Ah battery packs 18, 18′. However, a user may be prompted to insert a 9 Ah battery or larger.

In some embodiments, the first, second, and third system pre-checks 500, 600, 700 may occur in an alternate order or simultaneously. Additional or alternatively, the electrofusion tool 10 may only perform a subset of the pre-checks 500, 600, 700.

In some embodiments, the electrofusion tool 10 may monitor the temperature of the battery packs 18, 18′ in real-time via the temperature sensor 44. If the temperature of either of the battery packs 18, 18′ exceeds a set temperature threshold, the electronic control unit 20 stops the electrofusion and only resumes once the temperature of the battery packs 18, 18′ decreases below the set temperature threshold. In other embodiments, the temperature of the battery packs 18, 18′ may be required to reduce below a reboot temperature threshold that is less than the set temperature threshold to avoid the battery pack 18 shutting down immediately after restarting.

During the electrofusion, the electrical current traveling through the terminals 36, 38 of the pipe fitting 30 heats the conductive coil 34 within the pipe fitting 30, which melts at least portions of the pipe fitting 30 and/or the PE pipes P1, P2 to couple the components together. Once the fusion process is complete, the electrical leads 14 are removed from the pipe fitting 30 and the PE pipes P1, P2 are permanently joined together (step 470; FIG. 5).

Various features and advantages of the disclosure are set forth in the following claims.

What is claimed is:

1. An electrofusion tool used in joining pipe ends of plastic pipes together via a pipe fitting during an electrofusion process, the electrofusion tool comprising:
a housing;
a battery receptacle to selectively receive a rechargeable battery pack;
electrical leads extending from the housing and configured to transfer a current from the battery pack to the pipe fitting for permanently joining the pipe ends together; and
an electronic control unit configured to execute one or more steps, prior to initiating the electrofusion process, selected from a group consisting of:
a first system pre-check to determine whether an estimated peak operating current is less than an output capacity of the electrofusion tool,
a second system pre-check to determine whether an estimated electrical energy of the battery pack is less than a remaining charge capacity of the battery pack, and
a third system pre-check to determine whether an estimated operating temperature of the battery pack is less than a set temperature threshold of the battery pack.

2. The electrofusion tool of claim 1, wherein the battery pack supplies electrical current to the pipe fitting via the electrical leads when the first system pre-check, the second system pre-check, and the third system pre-check are satisfactory.

3. The electrofusion tool of claim 1, further comprising a scanner operable to scan the pipe fitting to obtain pipe fitting characteristics indicative of performance metrics for completing the electrofusion process.

4. The electrofusion tool of claim 3, wherein the first system pre-check includes the steps of
measuring a resistance of the pipe fitting by applying an electrical current to the pipe fitting and measuring a voltage drop across the electrical leads,
dividing a voltage specified from the pipe fitting characteristics by the resistance of the pipe fitting to obtain the estimated peak operating current, and
comparing the estimated peak operating current to the output capacity of the electrofusion tool.

5. The electrofusion tool of claim 4, wherein the first system pre-check fails when the estimated peak operating current is greater than the output capacity of the electrofusion tool.

6. The electrofusion tool of claim 3, wherein the second system pre-check includes the steps of
obtaining a remaining charge capacity of the battery pack,
calculating an estimated electrical energy required to complete the electrofusion process based on the pipe fitting characteristics of the pipe fitting, and
comparing the remaining charge of the battery pack with the estimated electrical energy.

7. The electrofusion tool of claim 6, wherein the second system pre-check fails when the estimated electrical energy is greater than the remaining charge capacity of the battery pack.

8. The electrofusion tool of claim 6, further comprising a voltage sensor to obtain the remaining charge capacity of the battery pack.

9. The electrofusion tool of claim 3, wherein the third system pre-check includes the steps of
estimating the operating temperature of the battery pack required to complete the electrofusion process based on the pipe fitting characteristics of the pipe fitting,
comparing the estimated operating temperature of the battery pack with the set temperature threshold, and
comparing the set temperature threshold with the estimated operating temperature of the battery pack.

10. The electrofusion tool of claim 9, wherein the third system pre-check fails when the estimated operating temperature is greater than the set temperature.

11. The electrofusion tool of claim 9, wherein the step of estimating the operating temperature of the battery pack is based on a present temperature of the battery pack and the pipe fitting characteristics of the pipe fitting required to complete the electrofusion process.

12. The electrofusion tool of claim 11, further comprising a temperature sensor to determine a present temperature of the battery pack, wherein the electronic control unit stops the electrofusion process when the present temperature of the battery pack becomes greater than the set temperature threshold.

13. A method of operating an electrofusion tool to join pipe ends of plastic pipes together via a pipe fitting during an electrofusion process, the method comprising:
coupling a battery pack to the electrofusion tool;
connecting electrical leads from the electrofusion tool to the pipe fitting;
scanning the pipe fitting to obtain pipe fitting characteristics; and
executing, by an electronic control unit of the electrofusion tool and prior to initiating the electrofusion process, one or more steps selected from a group consisting of:
a first system pre-check to determine whether an estimated peak operating current is less than an output capacity of the electrofusion tool,
a second system pre-check to determine whether an estimated electrical energy of the battery pack is less than a remaining charge capacity of the battery pack, and
a third system pre-check to determine whether an estimated operating temperature of the battery pack is less than a set temperature threshold of the battery pack.

14. The method of claim 13, further comprising supplying electrical current from the battery pack to the pipe fitting via the electrical leads in response to the first system pre-check, the second system pre-check, and the third system pre-check being satisfactory.

15. The method of claim 13, further comprising calculating the estimated peak operating current by determining a resistance of the pipe fitting by applying an electrical current to the pipe fitting and measuring a voltage drop across the electrical leads, and then dividing a voltage specified from the pipe fitting characteristics by the resistance of the pipe fitting.

16. The method of claim 13, further comprising calculating the estimated electrical energy to complete the electrofusion process by using the pipe fitting characteristics obtained from scanning the pipe fitting.

17. The method of claim 13, further comprising calculating the estimated operating temperature by using a present temperature of the battery pack and an electrical energy required to complete the electrofusion process.

18. The method of claim 17, further comprising providing a temperature sensor to determine the present temperature of the battery pack.

19. The method of claim 13, further comprising providing a voltage sensor to determine the remaining charge capacity of the battery pack.

20. The method of claim 13, wherein scanning the pipe fitting includes scanning a barcode encoded with the pipe fitting characteristics.
